(19) United States
(12) Patent Application Publication
(10) Pub. No.: US 2024/0313536 A1
(43) Pub. Date: Sep. 19, 2024

(54) Energy Supply Management System for a Vehicle, Energy Supply Management Method, and Computer Program Product

(71) Applicant: KNORR-BREMSE Systeme fuer Nutzfahrzeuge GmbH, Muenchen (DE)

(72) Inventors: Oliver JUNDT, Hessigheim (DE); Huba NEMETH, Budapest (HU); Jens-Hauke MUELLER, Velbert-Neviges (DE)

(21) Appl. No.: 18/576,436

(22) PCT Filed: Jun. 24, 2022
(86) PCT No.: PCT/EP2022/067356

§ 371 Date: Jan. 4, 2024

(30) Foreign Application Priority Data
Jul. 9, 2021 (DE) 10 2021 207 308.5

(51) Int. Cl. H02J 3/14; H02J 3/46

(52) U.S. Cl. CPC H02J 3/144; H02J 3/46; H02J 2310/48

(57) ABSTRACT

An energy supply management system for a vehicle, includes at least one energy supply system with at least one energy supply unit, and at least one load unit which has a specified functional scope and which can be connected to the at least one energy supply system in order to be supplied with energy. The energy supply management system is configured so as to determine an energy requirement of the at least one load unit for a specified driving maneuver, determine the energy which can be provided by the at least one energy supply unit in order to cover the energy requirement, and adapt the specified functional scope of the load unit, the specified driving maneuver, and/or the energy supply system when the energy which can be provided by the at least one energy supply unit in order to cover the energy requirement does not cover the energy requirement.

### CROSS REFERENCE TO RELATED APPLICATION

This application contains subject matter related to U.S. application Ser. No. ______, entitled “Energy Supply Management System for a Vehicle, Method for Determining the Coverage of an Energy Requirement of a Load Unit of the Energy Supply Management System, and Computer Program Product,” filed on even date herewith (Attorney Docket No. 037068.PH133US).

### BACKGROUND AND SUMMARY

The present invention relates to an energy supply management system for a vehicle, an energy supply management method for such an energy supply management system, and a computer program product for carrying out the method.

The increasing electrification of vehicles is resulting in widespread use of new vehicle components and vehicle architectures. By way of example, pneumatic or hydraulic systems are being fully or partially replaced by electrical or electronic components or function groups. In addition, automated or even autonomous driving applications are resulting in new requirements, in particular in regard to safety-related functions. This gives rise to a need for a reliable energy supply management system for vehicles, so that it is possible to ensure that the supply of energy at least for functions that are required for a driving maneuver is maintained. This relates not only to a supply of energy with electrical energy but can equally be applied to associated or independent pneumatic, hydraulic or hybrid systems.

To increase safety while maintaining an adequate supply of energy, especially in regard to safety-related functions, electrical energy supply systems, in particular of redundant design, are known that comprise both a main energy supply unit and at least one supplementary energy supply unit. A load connected to these supply units can therefore continue to be operated at least in part by way of the supplementary energy supply unit should the main energy supply unit fail.

In the event of the main energy supply unit failing and the supplementary energy supply unit being switched over or connected, an appropriate error signal can be forwarded to a superordinate processor unit. Such signal forwarding can be taken as a basis for executing an emergency program, for example, to transfer the vehicle to a safe state, said emergency program necessitating a stopping process from the vehicle or accordingly prompting the driver to accomplish this, for example. Since the supplementary energy supply unit can usually provide only a limited amount of energy, the stopping process is initiated immediately or within a predetermined period of time in order to still ensure an adequate supply of energy until the vehicle stops. The predetermined period of time may correspond here to the capacity of the supplementary energy supply unit. The actual energy requirement is not considered for this.

The emergency program described by way of illustration above can lead to a stopping process being initiated even though there is still sufficient energy available for continued travel according to a currently necessary energy requirement. In particular, there is a risk of the vehicle stopping in an awkward location, which in the worst case means a danger to the vehicle occupants or other road users. Even if this should not be the case, however, the stopping of the vehicle in any case means that the driving task is not performed and therefore, in particular in the commercial vehicle sector, deadlines are not met or delivery chains are interrupted.

In view of the statements above, the present invention is based on the object of providing an energy supply management system for a vehicle, an energy supply management method for such an energy supply management system and a computer program product for carrying out the method that allow(s) the safety of vehicle operation or else a range of the vehicle to be increased.

The object is achieved by an energy supply management system for a vehicle, an energy supply management method for such an energy supply management system, and a computer program product for carrying out the method according to the independent claims.

Advantageous developments of the invention are contained in the dependent claims.

According to the invention, an energy supply management system for a vehicle comprises at least one energy supply system having at least one energy supply unit and at least one load unit having a predetermined scope of functions, which is able to be connected to the at least one energy supply system in order to be supplied with energy. The energy supply management system is configured here to determine an energy requirement of the at least one load unit for a predetermined driving maneuver and to determine an energy that is able to be provided by the at least one energy supply unit to cover the energy requirement. In addition, the energy supply management system is configured to adapt the predetermined scope of functions of the load unit, the predetermined driving maneuver and/or the energy supply system if the energy that is able to be provided by the at least one energy supply unit to cover the energy requirement does not cover the energy requirement.

The energy supply system can comprise one or more energy supply units by way of which an electrical, pneumatic and/or hydraulic energy is able to be provided. An energy supply unit may accordingly be, by way of example, a battery or else a compressed air store for operating a pneumatic brake actuator as part of a load unit. A corresponding load unit is accordingly also not limited to an electronic unit or electrically operating load unit, but rather may alternatively or additionally process pneumatic control signals, for example. The energy supply units can also provide combined energy types. The energy supply system can moreover contain further elements, such as rectifiers or converters, in order to convert an energy into the energy form suitable for being drawn by the at least one load unit, and/or have combination points for combining multiple energy supply units. The load unit can be supplied with an appropriate energy by the energy supply system by way of a line connection from the load unit to the energy supply system or to at least one of the energy supply units of the energy supply system. The line connection may accordingly be a direct connection from the load unit to at least one of the energy supply units and/or an indirect connection via further components of the energy supply system, such as for example via a switching element. The line connection may be switchable in order to be able to make or break a connection between the energy supply system and the at least one load unit selectively or on demand. Alternatively or additionally, the load unit may also be able to be supplied with an inductive energy that is able to be supplied directly by way of appropriate arrangement of the energy supply system or of at least one energy supply unit configurable in this manner or indirectly via further transmission means. The ability to connect the at least one load unit to the at least one energy supply system or to the at least one energy supply unit of the at least one energy supply system may therefore also comprise an energy transmission connection by way of appropriate arrangement, as indicated by way of illustration for the supply of inductive energy.

The at least one load unit has at least one or more functions. Such a load unit may be here, by way of example, a steering function unit that has specific functions for the control, automatic control and/or other performance of a steering action. In other words, a steering function unit accesses steering components of a vehicle. Alternatively or additionally, a load unit may also be in the form of a braking function unit and/or HAD (Highly Automated Driving) function unit that accordingly has functions to access components of the braking devices and/or automated driving devices, or to control, automatically control and/or operate said components. The functions of the at least one load unit may therefore be signaling functions and/or directly actuator-related or mechanical functions. The functions may accordingly be implemented by way of control and/or automatic control devices, such as processor units, and/or actuators. The predetermined scope of functions may comprise, by way of example, all functions associated with the load unit, may be a scope of functions according to a basic setting of the load unit or may be a scope of functions that is in each case selected on the basis of the predetermined driving maneuver. The scope of functions of a basic setting or on the basis of the predetermined driving maneuver therefore corresponds to a predetermined subset of the entire scope of functions of the respective load unit. The predetermined scope of functions can also be predetermined by determining the specific available scopes of functions, so that the influence of faults or of failure of functions can also be considered in addition to the envisaged full or partial scope of functions. The predetermined scope of functions comprises the available or supposedly available functions and/or a functional state. The functional state relates to the characteristic of a function, for example a power range. For example, a steering function as the function can provide different steering powers as different steering functional states on the basis of the predetermined driving maneuver. The functional state may also be influenced by faults.

Based on the predetermined scope of functions, the energy supply management system can determine an energy requirement of the at least one load unit for a predetermined driving maneuver. If there are multiple load units, the energy requirement can be determined for each of the load units or else for all load units or at least a group thereof as the sum of the individual energy requirements, or on the basis of the sum of the respective scopes of functions.

The predetermined driving maneuver on which the determination of the energy requirement is based relates to a distance yet to be covered and/or a remaining driving time. The predetermined driving maneuver can result here for example from predefined navigation data for reaching a navigation destination or from a minimum range. The energy requirement can be determined here for example on the basis of current or average driving data, such as a vehicle speed, with accordingly expectable energy consumption values. The energy requirement can alternatively or additionally also be determined according to the energy consumption values associated with the driving maneuver. The determination of the energy requirement may be adaptable if for example data on which the determination is based change. The energy requirement is preferably determined in consideration of a predetermined safety factor. The safety factor can be considered for a respective predetermined scope of functions or else only predetermined functions. The safety factor may also differ and/or be alterable depending on the function and/or on the basis of a respective driving maneuver. The energy requirement can therefore be determined on the basis of an actual and/or forecast energy consumption with or without consideration of a safety factor. The forecast of energy consumption values in particular also considers the probability and frequency of a respective performance of a function, of a respective characteristic connected to the performance of a function and/or of a change in the probability and frequency of the respective performance of a function, or of the respective characteristic connected to the performance of a function. A performance of a function may be for example the performance of a steering function, the characteristic of which is again a steering power greater than a predetermined power value. The performance of the steering function in said characteristic can correspond for example to a number of curves on a predetermined route section or an average steering activity over a predetermined route length. According to this illustrative example, the probability of the steering function being performed with a power value greater than the predetermined power value can be ascertained and used to determine the energy requirement of the steering function or of the applicable load unit, possibly in consideration of further predetermined functions of the load unit or else of further forecast values for the steering function itself.

The energy that is able to be provided by the at least one energy supply unit to cover the energy requirement of the at least one load unit can be determined on the basis of a predetermined energy supply capacity of the at least one energy supply unit and/or corresponding state monitoring. Here too, there may be provision for an adaptation according to current capacity changes of the at least one energy supply unit.

If the energy requirement of the at least one load unit for a predetermined driving maneuver is greater than the energy that is able to be provided by the at least one energy supply unit to cover the energy requirement, the energy supply management is configured to take countermeasures. The countermeasures are used to possibly cover the energy requirement by way of an energy that is able to be provided. Accordingly, the energy supply management system may be configured by way of an appropriate control device and associated actuation to adapt the predetermined scope of functions of the load unit, the predetermined driving maneuver and/or the energy supply system. A control device can both contain active actuation functions and merely be provided as a communication device that transfers information to other system components in order to take said information as a basis for triggering individual control functions of the system components. The countermeasures above can therefore reduce the energy requirement and/or increase the energy that is able to be provided in order to allow at least extremely substantial coverage of the energy requirement by way of the energy that is able to be provided.

In one embodiment, the energy supply management system is configured to adapt the predetermined driving maneuver to obtain an adapted driving maneuver at least by changing a driving destination, a route selection and/or a speed of travel.

A change of the driving destination may be a change of a predetermined destination or of a predetermined remaining distance. Accordingly, the driving destination can be changed to an adapted destination or an adapted remaining distance. A change of the route selection may be for example an at least partial change of the route type, such as a transfer from a freeway section to a country road section or vice versa, or of a route layout, such as a transfer from a winding route section to a comparatively straight route section, to reach the same driving destination. The speed of travel can be changed as a further influencing variable for the driving maneuver, for example by way of a speed limit. Said influencing variables for the driving maneuver can be changed as single measures or else in combination. In part, changing one of the influencing variables also necessitates another influencing variable anyway. For example, a transfer from a freeway section to a country road section should, if driving properly, be directly accompanied by a reduction in speed. Accordingly, the predetermined driving maneuver becomes an adapted driving maneuver according to the change.

According to one development, the energy supply management system is configured to reduce the predetermined scope of functions of the at least one load unit to obtain a reduced-energy scope of functions of the at least one load unit that is able to be covered for the predetermined driving maneuver or for the adapted driving maneuver by the providable energy determined for coverage of the energy requirement by the at least one energy supply unit.

The reduction of the predetermined scope of functions to obtain a reduced-energy scope of functions correspondingly decreases the energy requirement of the at least one load unit. Such a reduction may be sufficient to be already covered by the energy that is able to be provided by the at least one energy supply unit for a predetermined driving maneuver. If the energy requirement for the reduced-energy scope of functions still cannot be covered by this measure, the reduced-energy scope of functions can be reduced further and/or a coverage for an adapted driving maneuver can be determined. Accordingly, the reduced-energy scope of functions can allow the predetermined or adapted driving maneuver to be performed. The predetermined scope of functions can be reduced to obtain a reduced-energy scope of functions by switching off specific or all functions and/or restricting specific functional states or even switching off the at least one load unit.

In particular, the reduced-energy scope of functions is limited to safety-related functions and/or safety-critical functions.

Accordingly, the scope of functions is reduced to obtain a minimum of functions and/or functional states required to be able to safely perform the predetermined or adapted driving maneuver. Safety-related functions contribute to the safety of vehicle operation. The safety-related functions therefore increase the safety of vehicle operation, but failure of said functions does not render vehicle operation impossible. During this time, safety-critical functions are absolutely essential for operation of a vehicle, i.e. vehicle operation should be stopped if said functions fail. Should the energy that is able to be provided by the at least one energy supply unit not be sufficient for the energy requirement of safety-related and safety-critical functions for a predetermined or adapted driving maneuver, the reduced-energy scope of functions is at least restricted to safety-critical functions. Depending on the energy surplus that is then still available, safety-related functions may continue to be part of the reduced-energy scope of functions. In such a case, the safety-related functions can be commenced according to a predetermined prioritization or a prioritization adapted for a driving maneuver, for example, and/or a respective energy requirement. The availability of the safety-related functions can be limited over time in order to be able to ensure that coverage of the energy requirement of the safety-critical functions for performing the predetermined or adapted driving maneuver is maintained.

In particular, the energy supply system is configured to adapt the determination of functions of the predetermined scope of functions as safety-related functions and/or safety-critical functions on the basis of the predetermined driving maneuver, the adapted driving maneuver, an operating mode of the vehicle and/or other active scopes of functions.

For example, one driving assistance system, such as a distance detection system, may be safety-critical in an autonomous driving mode of a vehicle as the operating mode, whereas it is only safety-related, if at all, when vehicle control is taken over by a driver. Classification of functions as safety-related or safety-critical functions may also be dependent on whether a specific function is able to be replaced by another function that is available in an active scope of functions. If for example at least part of a steering function of a steering actuator of the vehicle can be replaced by a braking function, the steering function may only be safety-related at least in a predetermined area.

According to one development, the energy supply management system comprises multiple load units and is configured to at least partially compensate for the reduced-energy scope of functions of at least one of the multiple load units by way of a predetermined scope of functions or by way of an adapted scope of functions of at least one other of the multiple load units.

As already described above, at least part of for example a steering function of a steering actuator of the vehicle can be replaced by a braking function. The steering function as the function of a scope of functions of a steering unit as at least one of the multiple load units may therefore no longer be available, for example, or may be available only in a restricted functional state in a reduced-energy scope of functions of the steering unit. The disappearance or the reduced functional state of the steering function can then be compensated for by way of the braking function of the braking unit as at least one other of the multiple load units, so that a safe driving mode can continue to be facilitated. The braking function per se here is part of a predetermined scope of functions, but may also be part of an adapted scope of functions with regard to a functional state that has changed to compensate for the steering function.

Proceeding from a predetermined functional state, a reduced-energy scope of functions differs from an adapted scope of functions in that the reduced-energy scope of functions is adapted with the aim of reducing the energy requirement of the respective load unit. An adaptation of a scope of functions resulting in an adapted scope of functions is not primarily used to reduce the energy of the respective load unit per se, but rather may also be focused on another adaptation. By way of example, an adapted scope of functions may also be matched to a changed operating mode and/or an adapted driving maneuver. The term adapted scope of functions does not exclude here a reduced-energy scope of functions either, however.

In particular, the adapted scope of functions of the at least one other of the multiple load units is adapted, in particular expanded, at least on the basis of the reduced-energy scope of functions of the at least one of the multiple load units.

The adaptation of the adapted scope of functions to compensate for functionalities of the one load unit that are no longer or not fully available as a result of the reduced-energy scope of functions by way of the at least one other load unit is therefore effected in a targeted manner. In other words, the adapted scope of functions here is a consequence of the reduced-energy scope of functions or at least is substantially determined thereby as well. Ultimately, however, the reduced-energy scope of functions is also a consequence of the adapted scope of functions insofar as the reduced-energy scope of functions can be reduced, at least with regard to safety-critical or else safety-related functions, only to the extent that this can be adequately compensated for by an adapted scope of functions.

In one embodiment, the energy supply management system comprises multiple load units and is configured to adapt the predetermined scope of functions, the reduced-energy scope of functions or the adapted scope of functions of at least one of the multiple load units on the basis of the predetermined scope of functions, the reduced-energy scope of functions or the adapted scope of functions of at least one other of the multiple load units.

Despite partial compensation for a reduced-energy scope of functions of at least one of the multiple load units, the respective scopes of functions can therefore also be adapted on the basis of one another by way of an adapted scope of functions of at least one other of the multiple load units. Particularly when looking at an energy supply management system having multiple load units, further optimization aims can arise. By way of example, an approximately even distribution of the scopes of functions of the respective load units may be an optimization aim in order to be able to respond to failure of a load unit by better offsetting the associated malfunction at the time of the failure. If the scopes of functions are distributed unevenly, the failure of the load unit having a relatively large scope of functions could otherwise at least temporarily be a substantial risk. A reciprocal adaptation of the respective scopes of functions with regard to a possible mutual at least partial compensation is not excluded here and may be an alternative or additional optimization aim. Furthermore, an optimization can also alternatively or additionally be carried out in respect of a total energy requirement. In this regard, various combinations of scopes of functions of multiple load units can be looked at that, overall, provide the same required or desired total scope of functions, in order to be able to select a combination with the lowest possible energy requirement.

According to one embodiment, the energy supply management system is configured to carry out the adaptation of the predetermined scope of functions, the reduced-energy scope of functions or the adapted scope of functions according to a predetermined prioritization of functions of the respective scopes of functions and/or of load units.

The predetermined prioritization allows the predetermined scope of functions, the reduced-energy scope of functions or the adapted scope of functions to be adapted for example in such a way that firstly safety-critical functions, then safety-related functions and only then other functions are maintained. Moreover, the safety-critical functions can be prioritized in such a way that firstly the safety-critical functions that cannot be compensated for by other functions of the individual and/or another load unit on its own or in combination are always maintained. Comparably, load units can also be prioritized.

In particular, the predetermined prioritization is able to be adapted on the basis of a predetermined or adapted driving maneuver.

As already discussed, the classification of functions as safety-critical, safety-related and other functions can change on the basis of a respective predetermined or adapted driving maneuver. Accordingly, the prioritization of functions and/or of load units containing these functions may be able to be adapted in order to be able to meet altered criteria.

In one embodiment, the energy supply management system comprises multiple energy supply units. The at least one load unit is connected here to a predetermined energy supply unit or to a group of the multiple energy supply units and the energy supply management system is configured to cover the energy requirement of the at least one load unit by adapting the energy supply system by connecting at least one further energy supply unit of the multiple energy supply units.

Accordingly, as an alternative or in addition to reducing the energy requirement and/or adapting the driving maneuver, a larger amount of energy may also be able to be provided to cover the energy requirement by connecting at least one further energy supply unit of the multiple energy supply units. The at least one further energy supply unit can be connected by activating the at least one further energy supply unit, which is connected to the at least one load unit in order to supply it with energy, and/or also a switching device for connecting the at least one further energy supply unit to the at least one load unit. A switching device also allows the at least one further energy supply unit to be connected to multiple load units selectively or in parallel.

In particular, the at least one connected energy supply unit is a redundant energy supply unit or an energy supply unit that is associated with at least one further load unit having a reduced-energy scope of functions or having a nonexhaustive energy requirement.

A redundant energy supply unit in this context is an energy supply unit that is initially not provided for the general supply of energy, but rather is able to be connected only when required, in particular if another energy supply unit fails. The energy that is able to be provided by the redundant energy supply unit may be at least the same as an energy that is able to be provided by at least one other energy supply unit, in order to be able to simultaneously replace the latter in the event of failure. Alternatively, the redundant energy supply unit may also have a low providable energy capacity, however, in order to act merely as a reserve energy supply unit. In another alternative, the connected energy supply unit may also be an energy supply unit that already provides another load unit with energy. Since the other load unit in such a case has a predetermined, reduced-energy or adapted scope of functions that does not exhaust the energy that is able to be provided by the connected energy supply unit, at least the difference can be used for further load units. If the load unit that is originally supplied with energy by this energy supply unit also has a lower prioritization, for example, the applicable connection to the energy supply can also be broken.

According to one embodiment, the energy supply management system is configured to determine the energy requirement of the at least one load unit for the predetermined driving maneuver or adapted driving maneuver at least on the basis of a remaining distance to a driving destination, route types, a route profile, route layouts, route disruptions and/or a volume of traffic, in particular on the basis of data from a navigation device.

The remaining distance to a driving destination can be determined from the current vehicle position and the navigation destination, for example. A route type may be a freeway, country road, a road in a town or else a track across fields. Route types correlate here, in a first approximation, with an average speed that is to be assumed. The route profile contains details about an incline, a substantially flat course and/or a decline in respect of a predetermined route section. Roadworks, route closures and other obstacles on a route section are examples of route disruptions. A temporary opening of a route or a route section can also be taken into consideration, such as for example a pedestrian zone that can be driven through, i.e. is open to vehicle traffic, only at particular times of day. The volume of traffic can be taken into consideration as moving, stop-start or stationary, for example. The aforementioned criteria can each influence an energy requirement that is to be forecast, and so this allows the energy requirement to be stated in concrete terms. Further updates to the alterable magnitudes of the specific criteria to be taken into consideration, such as updating of route disruptions and/or a volume of traffic, allow the energy requirement to be adaptable for the current situation.

In one embodiment, the at least one energy supply system comprises at least one main energy supply unit and at least one supplementary energy supply unit. The energy supply management system is configured here to determine the energy that is able to be provided by the at least one supplementary energy supply unit to cover the energy requirement of the at least one load unit for a predetermined or adapted driving maneuver.

A supplementary energy supply unit such as this is provided in particular as an energy supply unit that is redundant with respect to the main energy supply unit. If the main energy supply unit fails, this allows at least some of the functions of the at least one load unit to continue to be supplied with energy. The period of time for which the at least one load unit continues to be supplied with energy that is able to be provided via the supplementary energy supply unit is limited, however, if the supplementary energy supply unit has a lower capacity compared with the main energy supply unit. Particularly in this regard, it is accordingly advantageous to match the energy requirement and the energy that is able to be provided as accurately as possible.

By way of example, an energy supply system having a main energy supply unit and a supplementary energy supply unit can be operated in the form of a redundant energy management system. The redundant energy management system is connected to a steering functional unit, a braking functional unit and/or an HAD functional unit, for example. The redundant energy management system provides the supply of energy for the functional units as load units. If the main energy supply unit fails or if it does not have sufficient energy that is able to be provided, the at least one supplementary energy supply unit can be connected or, if possible, can completely undertake the supply of energy instead of the main energy supply unit.

Since, in such a configuration, the energy that is able to be provided by the at least one supplementary energy supply unit in view of failure of the main energy supply unit is, for safety reasons, crucial for maintaining the operability of the available functions or of at least a predetermined portion thereof, the energy that is able to be provided by the at least one supplementary energy supply unit to cover this energy requirement is advantageously determined. In particular, the energy that is able to be provided by the at least one supplementary energy supply unit to cover the energy requirement is determined only at a time when the main energy supply unit fails or has its power reduced, this being able to be determined continuously, periodically or on an event-dependent basis. As a result, the energy that is currently able to be provided by the at least one supplementary energy supply unit can be indicated if other processes mean that partial consumption has already taken place. Alternatively or additionally, the energy that is able to be provided by the at least one supplementary energy supply unit can also be determined in each case at a time after a connection between the supplementary energy supply unit and a load unit has been broken again, in order to determine the specific energy that is then still able to be provided. In such a case, the information about an energy that is still able to be provided in this regard is available directly without there first being a need to wait for a determination of current values when the main energy supply unit has failed. Accordingly, a determination of the energy requirement of the at least one load unit according to a predetermined scope of functions also advantageously relates to a time at which the at least one supplementary energy supply unit is connected or activated in order to provide the at least one load unit with energy. However, the energy requirement can also already be ascertained beforehand, for example as an average consumption, in order to then compare it with the energy that is able to be provided for coverage. In particular, the energy that is able to be provided by the supplementary energy supply unit to at least partially cover this energy requirement can also be determined beforehand, this being able to take place continuously, periodically or on an event-dependent basis.

According to one embodiment, a central processor unit of the energy management system, the at least one load unit, the at least one energy supply system and/or the at least one supplementary energy supply unit is/are configured to determine the energy requirement and/or the providable energy and/or to adapt the scope of functions of the load unit, the predetermined or adapted driving maneuver and/or the energy supply system.

The central processor unit of the energy management system can be a separate unit in which the energy requirement and/or the providable energy are determined and/or the scope of functions of the load unit, the predetermined or adapted driving maneuver and/or the energy supply system are adapted. The energy requirement and/or the providable energy can be determined here by the central processor unit according to stored system data and/or in sensor-based fashion.

The scope of functions of the load unit, the predetermined or adapted driving maneuver and/or the energy supply system can then in turn be adapted according to the determined energy requirement and the determined providable energy on the basis of database entries and/or algorithms. The above functionalities of the determination of the energy requirement and/or of the providable energy and adaptation of the scope of functions, the driving maneuver and/or the energy supply system can also be wholly or partially reproduced by the at least one load unit, the at least one energy supply system and/or the at least one supplementary energy supply unit. Partial reproduction by individual instances of said components can result in a respective further data interchange taking place to bundle information according to the on-demand destination determination. The central processor unit can perform a simple data interchange taking into consideration further interfaces, for example when using multiple energy supply systems. The further cited components can also be made simpler in this case, in particular not every individual component here requires the integration of processors or other electronic chips. An alternative or additional embodiment of the at least one energy supply system and/or of the at least one supplementary energy supply unit can be provided, however, in order to reduce a dependency on the central processor unit or at least to provide a redundancy.

In a further aspect, the present invention relates to an energy supply management method for an energy supply management system for a vehicle described above, comprising the steps of: determining an energy requirement of at least one load unit having a predetermined scope of functions for a predetermined driving maneuver, the load unit being able to be connected to at least one energy supply system having at least one energy supply unit in order to be supplied with energy, determining an energy that is able to be provided by the at least one energy supply unit to cover the energy requirement and adapting the predetermined scope of functions, the predetermined driving maneuver and/or the energy supply system if the energy that is able to be provided by the at least one energy supply unit to cover the energy requirement does not cover the energy requirement.

The advantages of the method arise analogously to the description of the corresponding energy supply management system, which is accordingly configured to perform the method steps. In particular features of the corresponding energy supply management system that are worded in terms of function can be regarded separately as features of the method.

In a further aspect, the present invention also relates to a computer program product having program code, which is stored on a machine-readable medium, for carrying out the method described above.

This allows vehicles to be upgraded, in particular in a simple manner.

The invention is explained in more detail below with reference to the accompanying figures.

### BRIEF DESCRIPTION OF THE DRAWINGS

FIG. 1 is a schematic representation of an energy supply management system according to an exemplary embodiment of the invention in a normal mode; and

FIG. 2 is a schematic representation of the energy supply management system shown in FIG. 1 in an emergency mode.

### DETAILED DESCRIPTION OF THE DRAWINGS

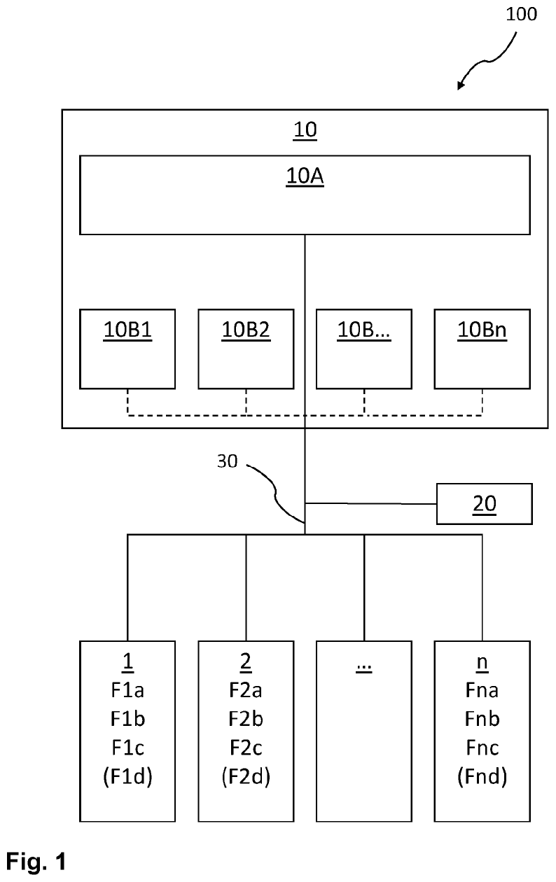

FIG. 1 shows a schematic representation of an energy supply management system 100 according to an exemplary embodiment in a normal mode. The energy supply management system 100 moreover comprises multiple load units 1, 2, . . . , n, which are supplied with energy via a line connection 30 from the energy supply system 10, and a central processor unit 20.

The energy supply system 10 comprises a main energy supply unit 10A and multiple supplementary energy supply units 10B1, 10B2, 10B . . . , 10Bn. The energy supply system 10 shown here is configured as a redundant energy management system. Accordingly, the load units 1, 2, . . . , n are supplied with energy by the main energy supply unit 10A via the line connection 30 in a normal mode, i.e. when the main energy supply unit 10A is in a fault-free state. If the main energy supply unit 10A fails or experiences a drop in energy, at least one of the multiple supplementary energy supply units 10B1, 10B2, 10B . . . , 10Bn can then be connected to the connecting line 30, as indicated by the dashed line connection in FIG. 1. The connection can be made for example by appropriate switching elements and/or by activation of the respectively provided supplementary energy supply unit 10B1, 10B2, 10B . . . , 10Bn.

In the normal mode, the load units 1, 2, . . . , n have a respective predetermined scope of functions F1a-c, F2a-c, . . . , Fna-c. The predetermined scope of functions comprises both the functions F1a-c, F2a-c, . . . , Fna-c and a respective functional state, for example a power range of the respective function, that is to say the function characteristic range thereof.

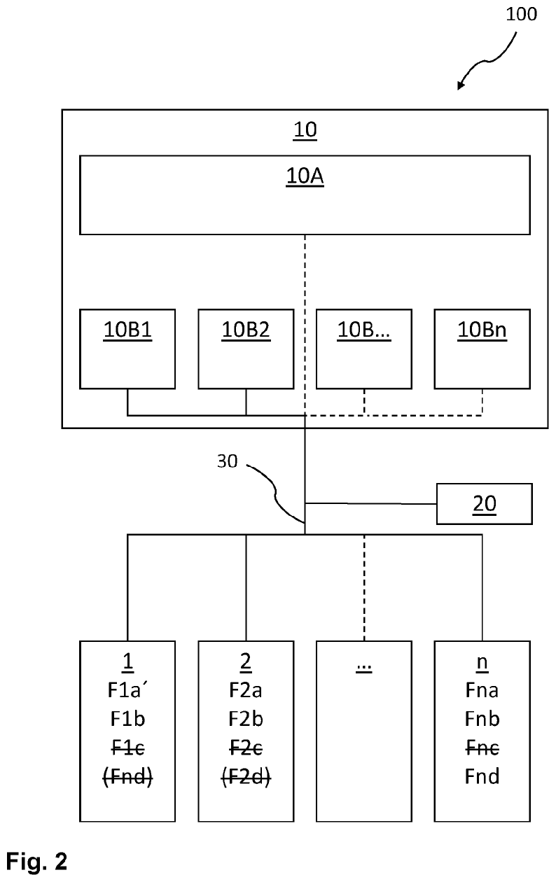

In the exemplary embodiment, the load unit 1 is a steering functional unit, the load unit 2 is an HAD (Highly Automated Driving) functional unit and the load unit n is a braking functional unit. The functions F1a, F2a, . . . , Fna are each safety-critical functions that are absolutely necessary for the respective operating mode for safety reasons in the normal mode. For example, the function F1a of the steering functional unit as load unit 1 is a steering power function having a predetermined minimum steering power. The functions F1b, F2b, . . . , Fnb are each safety-related functions that assist a safe driving mode, but are not absolutely necessary in an emergency. By way of example, the function F1b of the steering functional unit as load unit 1 is a steering assistance function (power-assisted steering) that facilitates a steering process. The functions F1c, F2c, . . . , Fnc are further functions that are neither safety-related nor safety-critical in the respective operating mode in the normal mode. In the embodiment shown, the functions F1d, F2d, . . . , Fnd are not active in the current operating mode in the normal mode and are functions that, in some cases, are able to be connected only in an emergency mode here, as will be discussed below with reference to FIG. 2. The functions F1d, F2d, . . . , Fnd may also be part of a predetermined scope of functions for another operating mode in a normal mode, however.

The central processor unit 20 is connected to the respective load units 1, 2, . . . n and also the main energy supply unit 10A and the supplementary energy supply units 10B1, 10B2, 10 . . . , 10Bn for signaling purposes, in the exemplary embodiment via the connecting line 30. The connecting line 30 is therefore designed not only for supplying energy, but also for signal transfer. The central processor unit 20 continuously monitors the availability of the main energy supply unit 10A and the supplementary energy supply units 10B1, 10B2, 10B . . . , 10Bn and also the amount of energy that each of these is able to provide. The central processor unit also continuously monitors the availability of the load units 1, 2, . . . , n and the predetermined scope of functions F1a-c, F2a-c, . . . , Fna-c thereof. In other embodiments, the monitoring can also alternatively or additionally take place periodically and/or on an event-dependent basis according to a selection option. By way of example, in an alternative embodiment such as this, the main energy supply unit 10A can be monitored continuously, while the supplementary energy supply units 10B1, 10B2, 10B . . . , 10Bn and/or the load units 1, 2, . . . , n, or their respective predetermined scope of functions F1a-c, F2a-c, . . . , Fna-c, are monitored only when the main energy supply unit 10A fails or indicates a predetermined drop in power. The central processor unit 20 is moreover configured to actuate the load units 1, 2, . . . , n in order for example to alter a predetermined scope of functions F1a-c, F2a-c, . . . , Fna-c. In addition, the central processor unit 20 is also configured to activate or deactivate the main supply unit 10A and the supplementary energy supply units 10B1, 10B2, 10B . . . , 10Bn, or to connect or disconnect them to/from the connecting line 30. In alternative embodiments, functionalities of the central processor unit 20 can alternatively or additionally, for example for redundancy reasons, also be undertaken wholly or in part by appropriate processor units of the loads 1, 2, . . . , n and/or of the energy supply system 10.

FIG. 2 shows a schematic representation of the energy supply management system 100 shown in FIG. 1 in an emergency mode. Here, the emergency mode is assumed to be a case in which the central processor unit 20 has detected failure of the main energy supply unit 10A. In other cases, however, the emergency mode may also be due to a drop in power at the main energy supply unit 10A or to a fault state, such as for example overheating. In the emergency mode, the central processor unit 20 disconnects the main energy supply unit 10A from the line connection 30, as indicated by the dashed line section from the main energy supply unit 10A. To continue to supply energy, the supplementary energy supply units 10B1 and 10B2 are activated, or are connected to the connecting line 30, as indicated by the line from the supplementary energy supply units 10B1 and 10B2, which is now solid in comparison with FIG. 1. The supplementary energy supply units 10B . . . , 10Bn are kept as a further reserve. In addition, the central processor unit 20 determines the energy requirement of the predetermined scopes of functions F1a-c, F2a-c, . . . , Fna-c of the load units for a predetermined driving maneuver and compares the determined energy requirement of the load units 1, 2, . . . , n with the total energy that is able to be provided by the supplementary energy supply units 10B1 and 10B2. The predetermined driving maneuver here corresponds to the remaining distance to a predetermined destination according to a predetermined navigation route.

In the exemplary embodiment shown in FIG. 2, the energy requirement of the load units 1, 2, . . . , n for the predetermined driving maneuver is greater than the energy that is able to be provided by the supplementary energy supply units 10B1 and 10B2. In order to still be able to perform the predetermined driving maneuver, the central processor unit 20 now deactivates all functions F1c, F2c, Fnc that are not safety-related or safety-critical. Deactivated functions are shown as crossed-out functions. Load units that contain no safety-related or safety-critical functions are completely deactivated, as identified by the dashed line. Moreover, the central processor unit 20 determines that part of the function F1a of the load unit 1, which is focused on a steering power, can be replaced by the function Fnd of the load unit n. The function Fnd relates to a single-sided braking function for initiating or assisting a steering process. Accordingly, the scope of performance of the function F1a can be reduced, corresponding to a function F1a′. The energy saving as a result of the power reduction from F1a to F1a′ is greater than the energy requirement of the function Fnd. Accordingly, the predetermined scope of functions F1a, F1b, F1c of the load unit 1 is adapted to obtain a reduced-energy scope of functions F1a′, F1b, and the predetermined scope of functions F2a, F2b, F2c of the load unit 2 is adapted to obtain a reduced-energy scope of functions F2a, F2b. The predetermined scope of functions Fna, Fnb, Fnc is firstly reduced to a reduced-energy scope of functions Fna, Fnb, but expanded by the function Fnd to obtain an adapted scope of functions in order to make up for the power reduction of the function F1a to F1a′. The reduced energy requirement as a result of the measures of the function adaptations can now be covered by the energy that is able to be provided by the supplementary energy supply units 10B1 and 10B2.

Even if only the adaptation of the predetermined scopes of functions as a measure to ensure that the predetermined driving maneuver is performed is described in the exemplary embodiment, it is alternatively or additionally also possible for the predetermined driving maneuver and/or the energy supply system 10 to be adapted. By way of example, a new driving destination can be selected and/or a route guidance to a driving destination can be adapted. Alternatively or additionally, a further supplementary energy supply unit 10B . . . , 10Bn can also be connected. In the exemplary embodiment, the adaptation of the predetermined scopes of functions F1a-c, F2a-c, . . . , Fna-c, followed by an adaptation of the energy supply system 10, is prioritized. Only when both measures are unable to achieve coverage of the energy requirement for a predetermined driving maneuver with sufficient certainty is the driving maneuver itself adapted. The prioritization may be able to be adapted by input from a vehicle driver. The processor unit 20 also continues to monitor adherence to the coverage of the previously forecast energy requirements and can carry out further adaptations if necessary.

The invention is not limited to the embodiments described. Even if multiple functions are indicated for each load unit in the embodiment described above, at least one load unit may also have only one function. The energy supply management system may also have only one load unit. In one embodiment, it is additionally possible, by way of example, for the order of deactivation of the respective function or reduction of the functional state to be provided within groups, such as for example a group of non-safety-related or non-safety-critical functions and/or a group of safety-related functions, according to a predetermined prioritization. It is also possible to switch to another driving mode in order to reduce the number of safety-critical functions and/or the energy requirement thereof overall.

### LIST OF REFERENCE SIGNS

1, 2, . . . , n load unit
10 energy supply system
10A main energy supply unit
10i1, 10B2, . . . , 10Bn supplementary energy supply unit
20 central processor unit
30 connecting line
100 energy supply management system
F1a-d, F2a-d, . . . , Fna-d functions

1.-17. (canceled)

18. An energy supply management system for a vehicle, comprising:
at least one energy supply system having at least one energy supply unit;
at least one load unit having a predetermined scope of functions, which is able to be connected to the at least one energy supply system in order to be supplied with energy, wherein
the energy supply management system is configured to:
determine an energy requirement of the at least one load unit for a predetermined driving maneuver,
determine an energy that is able to be provided by the at least one energy supply unit to cover the energy requirement, and
adapt the predetermined scope of functions of the load unit, the predetermined driving maneuver and/or the energy supply system, when the energy that is able to be provided by the at least one energy supply unit to cover the energy requirement does not cover the energy requirement.

19. The energy supply management system according to claim 18, wherein the energy supply management system is further configured to:
adapt the predetermined driving maneuver to obtain an adapted driving maneuver at least by changing a driving destination, a route selection, and/or a speed of travel.

20. The energy supply management system according to claim 18, wherein the energy supply management system is further configured to:
reduce the predetermined scope of functions of the at least one load unit to obtain a reduced-energy scope of functions of the at least one load unit that is able to be covered for the predetermined driving maneuver or for the adapted driving maneuver by the providable energy determined for coverage of the energy requirement by the at least one energy supply unit.

21. The energy supply management system according to claim 20, wherein
the reduced-energy scope of functions is limited to safety-related functions and/or safety-critical functions.

22. The energy supply management system according to claim 21, wherein
the energy supply system is configured to adapt the determination of functions of the predetermined scope of functions as safety-related functions and/or safety-critical functions on the basis of the predetermined driving maneuver, the adapted driving maneuver, an operating mode of the vehicle, and/or other active scopes of functions.

23. The energy supply management system according to claim 22, wherein
the energy supply management system comprises multiple load units and is configured to at least partially compensate for the reduced-energy scope of functions of at least one of the multiple load units by way of a predetermined scope of functions or by way of an adapted scope of functions of at least one other of the multiple load units.

24. The energy supply management system according to claim 23, wherein
the adapted scope of functions of the at least one other of the multiple load units is expanded at least based on the reduced-energy scope of functions of the at least one of the multiple load units.

25. The energy supply management system according to claim 22, wherein
the energy supply management system comprises multiple load units and is configured to adapt the predetermined scope of functions, the reduced-energy scope of functions or the adapted scope of functions of at least one of the multiple load units based on the predetermined scope of functions, the reduced-energy scope of functions or the adapted scope of functions of at least one other of the multiple load units.

26. The energy supply management system according to claim 22, wherein the energy supply management system is further configured to:
carry out the adaptation of the predetermined scope of functions, the reduced-energy scope of functions or the adapted scope of functions according to a predetermined prioritization of functions of the respective scopes of functions and/or of load units.

27. The energy supply management system according to claim 26, wherein
the predetermined prioritization is able to be adapted based on a predetermined or adapted driving maneuver.

28. The energy supply management system according to claim 18, wherein
the energy supply management system comprises multiple energy supply units,
the at least one load unit is connected to a predetermined energy supply unit or to a group of the multiple energy supply units, and
the energy supply management system is further configured to cover the energy requirement of the at least one load unit by adapting the energy supply system by connecting at least one further energy supply unit of the multiple energy supply units.

29. The energy supply management system according to claim 28, wherein
the at least one connected energy supply unit is a redundant energy supply unit or an energy supply unit that is associated with at least one further load unit having a reduced-energy scope of functions or having a non-exhaustive energy requirement.

30. The energy supply management system according to claim 18, wherein the energy supply management system is further configured to:
determine the energy requirement of the at least one load unit for the predetermined driving maneuver or adapted driving maneuver based on one or more of:
a remaining distance to a driving destination,
route types,
a route profile,
route layouts,
route disruptions, or
a volume of traffic.

31. The energy supply management system according to claim 18, wherein
the at least one energy supply system comprises at least one main energy supply unit and at least one supplementary energy supply unit, and
the energy supply management system is further configured to:
determine the energy that is able to be provided by the at least one supplementary energy supply unit to cover the energy requirement of the at least one load unit for a predetermined or adapted driving maneuver.

32. The energy supply management system according to claim 18, wherein
a central processor unit of the energy management system, the at least one load unit, the at least one energy supply system, and/or the at least one supplementary energy supply unit is/are configured to:
determine the energy requirement or the providable energy, and/or
adapt the scope of functions of the load unit, the predetermined or adapted driving maneuver, and/or the energy supply system.

33. A method of managing energy supply for an energy supply management system for a vehicle, comprising:
determining an energy requirement of at least one load unit having a predetermined scope of functions for a predetermined driving maneuver, the load unit being able to be connected to at least one energy supply system having at least one energy supply unit in order to be supplied with energy;
determining an energy that is able to be provided by the at least one energy supply unit to cover the energy requirement; and
adapting the predetermined scope of functions, the predetermined driving maneuver and/or the energy supply system when the energy that is able to be provided by the at least one energy supply unit to cover the energy requirement does not cover the energy requirement.

34. A computer product comprising a non-transitory computer readable medium having program code stored thereon which, when executed by one or more processors, carries out the acts of:
determining an energy requirement of at least one load unit having a predetermined scope of functions for a predetermined driving maneuver, the load unit being able to be connected to at least one energy supply system having at least one energy supply unit in order to be supplied with energy;
determining an energy that is able to be provided by the at least one energy supply unit to cover the energy requirement; and
adapting the predetermined scope of functions, the predetermined driving maneuver and/or the energy supply system when the energy that is able to be provided by the at least one energy supply unit to cover the energy requirement does not cover the energy requirement.
